(19) United States
(12) Patent Application Publication
(10) Pub. No.: US 2007/0160312 A1
(43) Pub. Date: Jul. 12, 2007

(54) Apparatus and method for registering images of a structured object

(75) Inventors: Thomas Blaffert, Hamburg (DE); Rafael Wiemker, Kisdorf (DE)

Correspondence Address: PHILIPS INTELLECTUAL PROPERTY & STANDARDS, 595 MINER ROAD, CLEVELAND, OH, 44143, US

(73) Assignee: KONINKLIJKE PHILIPS ELECTRONICS N.V., Eindhoven (NL)

(21) Appl. No.: 10/597,874

(22) PCT Filed: Feb. 2, 2005
(86) PCT No.: PCT/IB05/50433

§ 371 Date: Aug. 10, 2006

(30) Foreign Application Priority Data
Feb. 13, 2004 (EP) 04100580.2

(51) Int. Cl. G06K 9/32; G06K 9/00

(52) U.S. Cl. 382/294; 382/128

(57) ABSTRACT

The invention relates to an apparatus and a method for registering a first image (A1) with a second stored image (A2) of an object such as the chest (2) of a patient. The images (A1, A2) may, for instance, have been produced by an X-ray CT system (1) and be used in the trend control of lung tumors. The images (A1, A2) are automatically segmented into various object constituents (a, b, c). Following this, only image areas (B1, B2) of object constituents (b) relevant to the task in hand are registered. In the trend control of lung tumors, for instance, a registration of the lung areas (b) is sufficient.

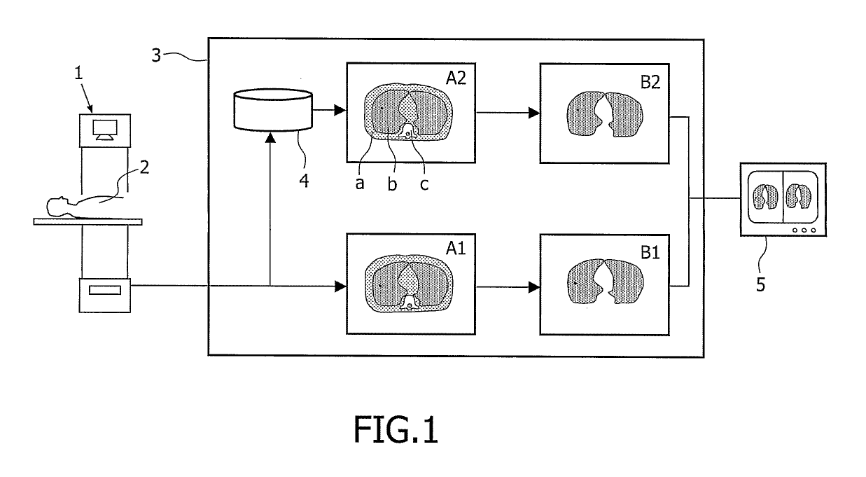

The invention relates to a data processing unit and to a method for registering a first image and a second image of a structured object, in particular for registering images for the trend control of lung tumors. It further relates to an examination apparatus incorporating a data processing unit of this type.

In medical image processing, two data volumes recorded at different times or using different modalities often have to be spatially coordinated (“registered”). By way of example for this situation, the trend control of lung tumors is discussed below, wherein X-ray or MNR images of a patient produced at different times are compared. In the associated image data, nodules or so-called “circular foci” (hereinafter together referred to as noduli) are detected in the lung, coordinated and compared with regard to size. An automatic alignment or registration of the various images enables the doctor to complete these tasks better.

The alignment of the images is usually achieved by point-to-point imaging from one image to the other, for instance in the form of transformations of rigid bodies, affine transformations or non-linear spline functions. The calculation of such transformations or the “image registration” essentially is an optimizing process based on a suitable similarity standard. Following the determination of the transformations, a realigned or “reformatted” image can be calculated. It is further possible to calculate the transformed location of object constituents or structures such as noduli.

In this context, US 2003/0146913 A1 describes a method for registering two lung images, wherein a user first interactively indicates a relevant reference point, such as a nodulus in the lung, on a first image. In the roughly pre-registered images, the location on the second image which corresponds to the indicated reference point is then calculated, whereupon in the proximity of said location the local volume most closely corresponding to the local volume around the reference point is looked for in a process involving much computing power.

On the basis of this background, it was an object of the present invention to provide means for the fast and accurate automatic registration of images of an object.

This problem is solved by a data processing unit with the features of claim 1 or 2 respectively, by an examination apparatus with the features of claim 8 and by methods with the features of claim 9 or 10 respectively. Useful embodiments are described in the dependent claims.

According to a first aspect, the invention relates to a data processing unit for registering a first image and a second image of a structured object. The structured object may, for instance, be the chest region of a patient, where various organs, such as the lungs, the heart, bone marrow, bones and muscular tissue, are located. The registration of two images of a chest volume is, for instance, required in the process of the trend control of lung tumors. The data processing unit is set up to execute the following steps:

The automatic segmentation of the first and second images into various object constituents. Suitable methods for such a segmentation are known from publications. A watershed transformation is particularly suited to this application.

The registration of only those image areas of the two images which are associated with selected corresponding object constituents, the selected object components having to be relevant to the task in hand. As a rule, the user of the data processing unit determines in advance which object constituents are “relevant” in a given situation. In the trend control of lung tumors, for instance, the lungs are the relevant object constituents.

The data processing unit described above offers the advantage that it allows a fully automatic registration of the images, the segmentation and the subsequent restriction of the registration to relevant image areas allowing, in the context of the given task, both a very precise and a fast execution. Individual user actions are not always necessary. The user merely decides (for instance by selecting an application-specific program mode) which object constituents are relevant to the task in hand and therefore to be registered.

According to a second aspect, the invention relates to a data processing unit for registering a first image and a second image of a structured object, which is set up to execute the following steps:

The automatic segmentation of said images into various object constituents.

The registration of image areas of various object constituents using individually assigned registration methods. The registration methods may be assigned a priori on the basis of known characteristics of the object constituents. Portions of soft tissue may, for instance, be registered by means of an affine transformation, while portions of hard tissue, such as bones, may be registered by means of a rigid transformation.

The data processing unit offers the advantage that a registration method best suited to the individual object constituents is used in each case. This reduces registration effort and costs to the necessary minimum while achieving a higher accuracy, for instance by ensuring that rigid object constituents are not (do not have to be) processed by means of an elastic transformation.

A data processing unit preferably incorporates the features of both the first and the second aspect. This means that, following an automatic segmentation, it registers only image areas of selected object constituents, and that various object constituents are processed using individually assigned registration methods.

Preferred further features of the invention are described below; these may relate to data processing units according to both aspects of the invention, but to simplify matters, only the term “data processing unit” is used.

The data processing unit may be set up for automatic classification of the segmented object constituents. Different object areas in a chest photograph may, for instance, be classified as “lungs”, “heart”, “bones” etc. Such a classification can optionally be based on the calculation of the average Hounsfield value of the image areas. The result of the classification can be used as a basis for the automatic selection of relevant image areas to be registered and/or for the selection of individually assigned registration methods.

The various images or image areas are preferably registered by linear registration on a plurality of resolution levels, a rigid registration on a coarse grid being followed by an affine registration on a finer grid. The registration on the coarse grid serves as a preparatory step for the subsequent affine registration, so that an accurate result of the latter is obtained more quickly. As an overall result of the process, an affine registration of the two images or the selected image areas is then available.

The first and/or the second image may, in particular, be a two- or three-dimensional computer tomogram, which may be an X-ray photograph or a magnetic resonance image. The first and second images may have been produced using either identical or different modalities.

The invention further relates to an examination apparatus comprising the following components:

An imaging device for producing images of an object. This may, for instance, be a computer tomographic X-ray or magnetic resonance system.

A data processing unit of the type described above coupled to said imaging device. This means that the data processing unit is used for registering a first and a second image of a structured object and is set up initially to segment the images automatically into various object constituents. The data processing unit is farther capable of registering image areas of selected object constituents and/or of processing various object constituents by means of individual registration methods.

The invention further relates to a method for registering a first image and a second image of a structured object, comprising the following steps:

The automatic segmentation of said images into various object constituents.

The registration of image areas of selected corresponding object constituents relevant to a given task.

The invention finally relates to a method for registering a first image and a second image of a structured object, comprising the following steps:

The automatic segmentation of said images into various object constituents.

The registration of image areas of various object constituents using individually assigned registration methods.

The two methods described above generally relate to the steps which can be executed with the data processing unit according the first or second aspect of the invention. With regard to the explanation of farther details, advantages and features, the above description therefore applies.

These and other aspects of the invention are apparent from and will be elucidated with reference to the embodiments described hereinafter.

The invention is explained below by way of example with the aid of the enclosed Figure. The single FIGURE is a diagrammatic representation of the components of an examination system according to the invention.

On the left-hand side of the FIGURE, an X-ray CT 1 is indicated as an imaging device for the production of two- or three-dimensional images of an object. The present application is based on the trend control of lung tumors. Images of the chest region 2 of a patient are produced with the CT system 1 and transferred to a connected data processing unit 3. The data processing unit 3 is as usual provided with the required components, such as a central processing unit (CPU), volatile memories (RAM), permanent memories (hard disc 4, CD . . .), interfaces with peripherals and the like. These hardware components are not shown in detail in the Figure, which instead concentrates on the principal sequence of the image processing process which can be executed by the data processing unit 3 using suitable programs.

The images produced by the CT system 1 can, in particular, be stored in a permanent memory 4 of the data processing unit 3. In this way, images A1 currently produced by the CT system 1 can be compared to older stored images A2 in order to track the development (new occurrence, disappearance, size change etc.) of lung tumors or suspected noduli (circular foci) in the lung.

For trend control, an examining doctor has to find noduli on the old image A2 and the new image A1 and coordinate them correctly. This coordination is, however, made difficult by the fact that the two images A1, A2 are usually geometrically different from one another, i.e. not congruent, as a result of the patient's changes in position and of the displacement and deformation of organs. For this reason, the automatic alignment or registration of the two images A1, A2 is a desirable preparatory step. On the one hand, this registration has to be completed as fast as possible, while having to be as accurate as possible in the relevant lung regions on the other hand. To achieve this, the procedure explained in greater detail below is proposed.

The images A1, A2 to be compared are first automatically segmented by the data processing unit 3. The term “segmentation” as usual describes the assignment of image points (pixels or voxels) to different classes or object constituents. This automatic segmentation may, for instance, be achieved with the aid of a watershed transformation dividing the whole image area into various image areas or regions. Suitable algorithms for this purpose are known from publications (such as L. Vincent, P. Soille, Watersheds in Digital Spaces: An Efficient Algorithm Based on Immersion Simulations, IEEE Trans. Pattern Anal. Machine Intell., 13(6), 583-598, 1991). Said image areas may then be automatically classified and assigned to various object constituents, such as muscular tissue a, lungs b, heart c, bones, cavities etc. A classification of this type can be based on features of the image areas, in particular on the Hounsfield value.

After this segmentation and classification, it is established which image areas are associated with which object constituents a, b, c. Any subsequent processing steps can therefore be restricted to object constituents relevant to the task in hand. In the trend control of lung tumors, the only relevant object constituents are the lungs b. From complete images A1, B2, the reduced images B1, B2 are now generated, omitting all irrelevant object constituents a, c. These images B 1, B2 reduced to the essential features can then be registered using conventional methods. As a result of this restriction to selected image areas, the relevant areas can be registered more quickly and with a higher degree of accuracy. This process is further accelerated by the fact that simpler transformation methods (for instance linear methods instead of splines) can be used while the accuracy remains constant in the relevant area. After the registration, the images (whole or restricted to the relevant image areas) can be displayed, for instance on a monitor 5, either next to or superimposed on one another.

For registering the partial images B1, B2, a fast method based on multiple resolution levels is preferably used. In a first step, rigid bodies are registered on a coarse resolution grid, whereupon the registration is improved in a second step by affine registration on a finer resolution grid. The overall result of this procedure is an affine transformation matrix for the whole of the lung volume.

According to a further feature of the method, the image areas of various object constituents a, b, c determined during the segmentation process can be used to assign said image areas to defined types of tissue. This information can then be used for the individual definition of locally determined registration parameters which vary with tissue characteristics, such as elasticity. By such a registration including tissue types, the accuracy of the total process is improved considerably. It is, for instance, possible to transform bones and comparable body structures by means of a rigid registration, while softer tissues require a more flexible transformation.

1. A data processing unit for registering a first image and a second image of an object, the data processing unit being set up to:
segment the images automatically into various object constituents
register only those image areas of selected object constituents which are relevant to a predetermined task.

2. A data processing unit for registering a first image and a second image of an object, in particular a data processing unit as claimed in claim 1, which is set up to:
segment the images automatically into various object constituents
register the image areas of various object constituents using individually assigned registration methods.

3. A data processing unit as claimed in claim 1, wherein the segmented object constituents are automatically classified.

4. A data processing unit as claimed in claim 1, wherein a linear registration is performed on several resolution levels, rigid bodies being registered on a coarse grid followed by affine registration on a finer grid.

5. A data processing unit as claimed in claim 1, wherein the first image and/or the second image are/is (a) two- or three-dimensional computer tomogram(s), in particular an X-ray photograph or a magnetic resonance image.

6. A data processing unit as claimed in claim 1, wherein the object is the chest of a patient, the lungs being the object constituent relevant to a tumor diagnosis.

7. A data processing unit as claimed in claim 1, wherein the segmentation is performed using a watershed transformation.

8. An examination apparatus, comprising:
an imaging device for producing images of an object;
a data processing unit as claimed in claim 1, coupled to the imaging device.

9. A method for registering a first image and a second image of an object, comprising the following steps:
automatic segmentation of the images into various object constituents;
registration of the image areas of selected object constituents relevant to a predetermined task.

10. A method for registering a first image and a second image of an object, comprising the following steps:
automatic segmentation of the images into various object constituents,
registration of the image areas of various object constituents using individually assigned registration methods.
